(19) United States
(12) Patent Application Publication
(10) Pub. No.: US 2022/0001427 A1
(43) Pub. Date: Jan. 6, 2022

(54) Method for the treatment of surfaces

(71) Applicants: Ewald Dörken AG, Herdecke (DE); SLCR Lasertechnik GmbH, Duren (DE)

(72) Inventors: Christian RABE, Iserlohn (DE); Christian LENZMANN, Schwerte (DE); Hans-Jörg MINAS, Paderborn (DE); Olav SCHULZ-GAUS, Bergheim (DE); Philipp KURZE, Niederzier (DE)

(21) Appl. No.: 17/367,162

(22) Filed: Jul. 2, 2021

(30) Foreign Application Priority Data
Jul. 3, 2020 (EP) 20183973.5

(51) Int. Cl. B08B 7/00; B05D 3/06; B05D 3/00; C23G 5/00

(52) U.S. Cl. CPC B08B 7/0042; C23G 5/00; B05D 3/002; B05D 3/06

(57) ABSTRACT

The subject-matter of the present invention is a method and an apparatus for collectively treating the surfaces of a plurality of objects.

### CROSS REFERENCE TO RELATED APPLICATIONS

This application claims the benefit of priority under 35 U.S.C. § 119 to European Application No. 20 183 973.5, filed Jul. 3, 2020, the disclosure of which is hereby incorporated by reference in its entirety.

### FIELD

The present invention relates to the technical field of treating surfaces, in particular modifying surface properties or cleaning surfaces. In particular, the present invention relates to a method for the collective treatment of the surfaces of a plurality of objects. Furthermore, the present invention relates to an apparatus for the collective treatment of the surfaces of a plurality of objects. Finally, the present invention relates to a method for coating a plurality of objects.

### BACKGROUND

In order to enable good and sufficient adhesion of coatings to a surface, it is necessary that the surface comprises good adhesive properties and that the adhesion is not deteriorated, for example, by adhering contaminants in confined areas or even over a large area.

In addition, it is essential, in particular for industrial coating processes, that the surface to be coated comprises comparable and virtually homogeneous properties everywhere, so that a uniform coating, both of a single object and of a large number of objects, is possible. This is of particular interest in the case of functional coatings, such as anti-corrosion coatings, in particular zinc flake coatings or electrodeposited zinc or zinc alloy coatings, or decorative coatings. In all cases, sufficient and consistent adhesion of the coating to the surface of the coated object with a uniform and defined coating thickness is necessary to ensure the proper functions, in particular corrosion protection properties, or also a desired high-quality visual and haptic impression.

In order to constantly obtain the same surface properties for objects to be coated, in particular in industrial processes, the objects are cleaned or pre-treated with physical or chemical agents prior to the actual coating process. In the case of metallic objects, a combination of wet-chemical cleaning and physical, in particular mechanical, cleaning is generally used. Wet chemical cleaning is in particular hot alkaline degreasing or pickling or degreasing by immersion in a solvent bath. Mechanical cleaning is usually performed by blasting, either by shooting stainless steel balls or particles of ceramic or mineral materials at high speed onto the surface to be cleaned, or by abrasion. In addition, the metallic surface is often additionally phosphated in order to obtain a phosphating layer as an adhesion promoter and to further strengthen the adhesion of subsequently applied coatings to the metal surface. Furthermore, conversion coatings, such as oxsilane, are also applied to the surfaces to achieve satisfactory surface properties.

Cleaning or pretreatment removes unwanted adhesions from the surface of metallic or metal-containing objects or layers or objects to be coated in general, in particular rust, corrosion products, grease or other production residues, and if necessary, also roughens them in order to obtain reproducible surface properties suitable for uniform coating.

For larger, isolated components, pretreatment can also be carried out by laser irradiation. However, laser cleaning of this kind is generally only used for spot cleaning of specific components, such as the removal of scaling residues in the area of weld seams, in the targeted preparation of large automotive components for painting and bonding, e.g. battery coolers of electric cars, or in the targeted cleaning of tire interiors. In each case, however, the laser is used for targeted processing with precise contouring of defined surface areas.

Smaller parts, so-called mass-produced or mass bulk material, for which the targeted or precise cleaning and coating of individual parts is economically unviable or impractical, are cleaned or pretreated using the wet chemical methods described above or by means of blasting. For this purpose, however, not only the suitable materials, i.e. blasting agents or chemicals, would have to be kept available, which causes costs in acquisition and storage, but also the used cleaning agents have to be disposed of or cleaned again at great expense.

In addition, the use of flammable or corrosive chemicals that are harmful to health is unfavorable for reasons of environmental protection and occupational safety, and must be minimized.

Usually, in particular for the treatment of mass-produced bulk material, it is necessary to clean and degrease the parts wet-chemically on the one hand, in particular by hot alkaline treatments or the use of solvents, and on the other hand to remove adhering contaminants, in particular corrosion products, such as rust or scale, by means of blasting.

Only the combination of both pretreatment or cleaning steps can often ensure uniform and consistent surface properties of the mass-produced bulk material and provide consistently uniform coatings on an industrial scale.

### SUMMARY

However, the problems described above for the example of metallic mass-produced bulk materials apply generally to the surface treatment of bulk materials. Individual treatment of individual objects is not possible for reasons of cost and time, and for the collective treatment of surfaces, whether for cleaning or also for changing the surface properties, for example by roughening or hardening, chemical or physical surface treatment agents usually have to be used in large excess, which subsequently have to be recovered at great expense or disposed of at high cost.

Consequently, the state of the art still lacks a simple reproducible method that allows the surfaces of mass-produced bulk materials, in particular small parts, to be treated easily and the surface properties to be adjusted in a targeted manner. In particular, there are no satisfactory methods that make it possible to specifically change the surface properties of mass-produced bulk material, for example to specifically harden or roughen surfaces, or to carry out various surface treatments in a uniform method.

In particular, the state of the art lacks a method that allows the surfaces of mass-produced bulk material, in particular small parts, to be cleaned and pretreated in such a way that subsequent coating on an industrial scale is possible, and if possible in a single method step of cleaning.

Similarly, a method for cleaning or pretreating mass-produced bulk material, in particular small parts, which does not involve the use of hazardous substances and the wasteful use of consumables has been lacking up to now.

Thus, one object of the present invention is to avoid, or at least to mitigate, the disadvantages of the methods for surface treatment of mass-produced bulk material, in particular small parts, mentioned in the prior art.

An object of the present invention is further to provide a simple and reproducible method for the surface treatment of mass-produced bulk material, in particular small parts, with which a plurality of different surface treatments can preferably be carried out simply and flexibly.

In particular, it is an object of the present invention to avoid, or at least to mitigate, the disadvantages of the known cleaning processes mentioned in the prior art.

In particular, an object of the present invention is to provide a simple and reproducible method for the cleaning or pretreatment of mass-produced bulk material, which makes it possible to obtain coatable surfaces in a single method step.

A further object of the present invention is to provide a method which does not require the use of hazardous substances or the costly disposal of used cleaning agents.

Subject-matter of the present invention is a method for the collective treatment of the surfaces of a plurality of objects according to claim 1; further, advantageous embodiments of this aspect of the invention are subject of the respective dependent claims.

Further subject-matter of the present invention—according to a second aspect of the present invention—is an apparatus according to claim 15; further, advantageous embodiments of this aspect of the invention are subject of the respective dependent claims.

Finally, subject-matter of the present invention—according to a third aspect of the present invention—is a method for coating a plurality of objects according to claim 19; further, advantageous embodiments of this aspect of the invention are subject of the respective dependent claim.

It goes without saying that special features, characteristics, embodiments and advantages or the like which are set forth below—for the purpose of avoiding unnecessary repetition—with respect to only one aspect of the invention apply, of course, accordingly with respect to the other aspects of the invention, without the need for express mention.

Furthermore, it applies that all values or parameters or the like mentioned in the following can in principle be determined or measured by standardized or explicitly stated determination methods or by determination methods familiar to the person skilled in the art in this field.

Furthermore, it goes without saying that all weight- or quantity-related percentages are selected by the person skilled in the art in such a way that the total results in 100%.

With this proviso made, the present invention will be described in more detail below.

### BRIEF DESCRIPTION OF THE DRAWINGS

The figures show according to

FIG. 1 an apparatus for carrying out the method according to the invention in batch mode by means of a swivel drum;

FIG. 2 an apparatus for carrying out the method according to the invention in batch mode by means of a troughed belt;

FIG. 3 an apparatus for carrying out the method according to the invention in continuous operation;

FIG. 4 an electron micrograph of a screw head in the untreated state;

FIG. 5 the analytical data of the untreated surface obtained from the image according to FIG. 4;

FIG. 6 a microscopic image of a screw head after conventional pretreatment by hot alkaline degreasing and subsequent irradiation;

FIG. 7 the elemental analysis corresponding to FIG. 6;

FIG. 8 a microscopic image of a screw head cleaned by the method according to the invention;

FIG. 9 the elemental analysis associated with FIG. 8 of the surface of the screw head treated according to the invention;

FIG. 10 the results of a paint adhesion test according to DIN EN ISO 10683 on conventionally treated screws and

FIG. 11 the results of a paint adhesion test according to DIN EN ISO 10683 on screws treated according to the invention.

### DETAILED DESCRIPTION

Thus, subject-matter of the present invention—according to a first aspect of the present invention—is a method for the collective treatment of the surfaces of a plurality of objects, wherein the treatment of the surfaces is performed by irradiation with laser radiation.

For, as the applicant has surprisingly found out, laser irradiation on mass-produced bulk materials makes it possible to carry out almost any surface treatment of mass-produced bulk materials. In particular, it is possible to clean the surfaces of mass-produced bulk material, in particular small parts, collectively, i.e. in a chaotic process. By changing the position of the bulk material during the surface treatment, it can be achieved that all surfaces are statistically irradiated to an extent that the desired surface properties are always achieved.

In particular, the method according to the invention allows the treatment or pretreatment of surfaces made of almost any material, such as metal, plastics, wood, ceramics, etc. By suitable selection of laser energy and wavelength, various surface treatments can be carried out, such as removal of impurities, in particular inorganic and organic residues, from the surface, selective roughening of the surfaces or also hardening of the surfaces. It is particularly advantageous that, within the scope of the present invention, the various surface treatments can be carried out in parallel, i.e. simultaneously, or in immediate succession in one apparatus.

In particular, by using different lasers, either simultaneously or sequentially, different surface treatment steps can be carried out simultaneously or at least in one method. For example, CO₂ lasers can be used particularly well to remove organic contaminants from surfaces, while fiber lasers can be used to remove inorganic contaminants or to roughen surfaces in a targeted manner, for example.

The method according to the invention is thus generally a method for achieving a uniformly treated or uniformly modified surface of the mass-produced bulk material, in particular of the small parts.

Preferably, small parts, in particular in the form of mass-produced bulk material, can be easily and inexpensively treated, in particular pretreated and cleaned, by treating the small parts or the mass-produced bulk material collectively, i.e. not individually but rather bulkwise, by means of laser radiation. Such laser cleaning processes have so far only been carried out on individual parts or isolated parts and not in chaotic systems, such as bulk material.

Preferably, it is also provided in the context of the present invention that the treatment of the surfaces is selected from cleaning and/or modifying the surface. Modification of the surface is in particular adjustment of roughness, in particular smoothing or roughening, rounding, removal of burrs or hardening. In this context, modification of the surface is preferably understood to mean a change in the surface properties.

If the process according to the invention is carried out as a surface treatment for adjusting the roughness, it is usually provided in the context of the present invention that an Rₐ-value according to DIN 4287 of <50 μm, preferably <20 μm, is employed. Similarly, it may be provided in the context of the present invention that an Rₐ-value in the range of 1 to 50 μm, preferably 1 to 20 μm, is employed according to DIN 4287.

In the following, many aspects and advantages of the invention are explained by way of example on the basis of the pretreatment or cleaning and subsequent coating of metallic or metal-containing bulk material, but they also apply correspondingly to other surface treatments, since these can be carried out in the same way as the process with slightly different processing parameters adapted in each case. In particular, metallic or metal-containing bulk material and bulk material made of wood can be processed with very similar process parameters.

The process according to the invention makes it possible, for example, to replace the usually performed two-stage pretreatment or cleaning of bulk material from metallic or metal-containing objects in the form of, in particular, hot alkaline degreasing and subsequent blasting to remove corrosion residues by a one-step process, namely irradiation with laser radiation, or to limit the scope of these process steps.

The process according to the invention is characterized in particular by the fact that no hazardous substances, such as organic solvents or acids/alkalis, need to be used and, in addition, no consumables, such as stainless-steel beads or ceramic or mineral granules, are required, which must either be disposed of or cleaned at great expense. In addition, aqueous cleaning agents or solid substances (abrasives) can penetrate into the components or into pores and blowholes, from which they are then difficult to remove again.

A special feature of the process according to the invention can further be seen in the fact that the process durations can be significantly reduced, since laser cleaning usually does not have to take any longer than the treatment of bulk material in a blasting system, i.e. the process duration for carrying out degreasing can be completely saved in this case.

The process according to the invention has clear advantages over both wet chemical pretreatment and mechanical pretreatment: for example, there is no need to handle hazardous substances, and there is also no need for complex wastewater treatment. In addition, the costs for the blasting medium and the disposal of the blasting dust residues are eliminated.

The method according to the invention is thus significantly more economical and resource-saving, i.e. more sustainable, than the usual, in particular two-stage, pretreatment or cleaning methods for treating mass-produced bulk material.

In the context of the present invention, collective treatment or surface treatment means in particular that the parts or objects to be treated are not pretreated or cleaned individually, but together and not spatially separated from one another, but in particular also in loose bulk. The surface treatment thus preferably takes place under chaotic conditions.

It is astonishing that by treating, in particular cleaning, mass-produced bulk material with laser radiation comparable results can be achieved as with the use of blasting media, wherein in comparison to blasting a preceding degreasing of the parts to be treated can often be completely dispensed with. Surprisingly, it has been found that the parts are also cleaned outside the focus of the laser radiation. It was not foreseeable that, despite the low area power of the laser, the components would also be cleaned outside the focus of the laser radiation and that it would thus be possible to obtain coatable surfaces that meet the same requirements as the usual pretreatment and cleaning processes of the prior art.

According to a preferred embodiment of the present invention, it is provided that the objects are present in bulk, in particular in loose bulk, preferably in the form of a multilayer bulk. When such a bulk, in particular loose or also multilayer bulk, is mixed, it can be surprisingly ensured that statistically all surfaces of the individual parts are treated, for example cleaned, to a sufficient extent to ensure uniform surface properties and to enable, for example, well-adhering and functional coatings. The wavelength and energy of the laser radiation as well as the treatment time must be adapted in each case to the material to be processed and the type of surface treatment, such as cleaning, roughening, etc. For the surface treatment, it is generally not necessary for all objects to be at least temporarily in the focus of the laser radiation; rather, adjacent areas are apparently also irradiated to a sufficient extent.

According to a preferred embodiment of the present invention, it is provided that the objects are in the form of bulk material, in particular mass-produced bulk material.

Within the scope of the present invention, the material of the objects, in particular of the bulk material, preferably of the small parts, can usually be selected from almost any materials. Typically, however, the objects comprise or consist of a material selected from wood, plastic, ceramic, metal and mixtures thereof. Preferably, the objects comprise a material selected from wood, plastic, ceramic, or metal and mixtures thereof. Most preferably, the objects are metallic or metal-containing objects.

Now, as far as the material of the metallic or metal-containing objects is concerned, this can be selected from a variety of metals. However, it is usually provided that the material of the metallic or metal-containing objects is selected from aluminum-, copper- and iron-containing materials as well as mixtures and alloys thereof, in particular iron alloys and aluminum alloys, preferably steel or steel alloys.

Aluminum and aluminum alloys and, in particular, steel alloys are usually prepared for further coating processes by means of degreasing and subsequent mechanical blasting processes. Other metallic materials such as copper and its alloys can also be surface treated as mass-produced bulk materials using laser radiation.

Non-metallic objects in general can be surface treated as mass-produced bulk material by means of laser radiation in a comparable way. Only the wavelength of the laser and the laser power must be selected according to the material used and the treatment to be performed.

In the context of the present invention, it may be provided that the objects are selected from small parts, in particular screws, nuts, bolts and rivets, stamped parts, in particular stamped-bent parts, cast parts and pressed parts. The objects are in particular mass-produced bulk materials which simply for reasons of economy and manageability of the usually small parts are collectively pretreated or cleaned and coated, i.e. each individual part is not treated separately. In addition to small parts for industrial production, any other small parts, such as small useful objects like key rings, lids, etc. or decorative articles, can also be processed using the method according to the invention.

Particularly good results are obtained in the context of the present invention when the position of the individual objects relative to one another is changed during treatment. In particular, it has been well proven when the objects are mixed during the treatment. By mixing the objects thoroughly, it is achieved that the laser radiation or the laser beams always strike other or changing surfaces or other locations or changing locations of the surfaces of the individual parts.

By mixing or circulating the objects, it is in particular ensured that constantly different or changing surfaces of the objects enter the effective range of the laser. In this context, it appears in particular that a treatment, in particular cleaning, of the surfaces of the objects, in particular metal-containing or metallic objects, also takes place outside the range of the actual laser focus.

Particularly good results are obtained in this context if the position of the objects is changed continuously and/or permanently. Likewise, it can be provided that the objects are continuously and/or permanently mixed.

The mixture can preferably also be continuously mixed during the irradiation with the laser radiation and thus new surfaces or parts of the surfaces of the parts to be cleaned can constantly be exposed to the laser radiation.

Usually, in the context of the present invention, the objects are mixed by means of a mixing device. Particularly good results are obtained if the mixing device is selected from screws, in particular conveyor screws, caterpillar belts, troughed belts, swivel drums or rotary drums. Thus, the same devices can be used as in blasting plants.

In addition, it is possible for the treatment, in particular pretreatment or cleaning, to be carried out continuously or discontinuously, in particular in batch mode. Continuous methods operate, for example, with screws or caterpillar belts, while discontinuous methods, namely in particular batch methods, operate with troughed belts, swiveling drums or rotating drums.

Generally, in the context of the present invention, it is envisaged that during cleaning, contaminants, in particular adhesions, are removed from the surface of the objects, in particular that of the metallic or metal-containing objects.

Usually, the contaminations consist of inorganic adhesions, preferably corrosion products, in particular scale and rust, organic adhesions, in particular oils and greases, or mixtures thereof. The adhesions or contaminants are in particular production residues, such as scale or residues of hardening salts, or also greases and oils, which are applied for corrosion protection purposes.

If the method according to the invention is carried out as a method for pretreatment or cleaning, the surfaces of the objects, in particular of the metallic or metal-containing objects, are at least technically cleaned so that a uniform and stable adherent coating is ensured. The surfaces obtained with the pretreatment or cleaning according to the invention meet in particular the common technical specifications of the automobile manufacturers for subsequent coatings.

In the context of the present invention, particularly good results are obtained when the irradiation with laser radiation is carried out at least area-wise, preferably area-wise. In the context of the present invention, it is usually not necessary to always completely irradiate all surfaces of the objects with the laser. Rather, it is sufficient if areas or paths on the surface of the bulk material are cleaned by means of laser radiation. With sufficient mixing, all surfaces are cleaned in a short time.

According to a more preferred embodiment of the present invention, the method according to the invention is carried out in such a way that
(a) in a first method step (a), a plurality of objects is introduced into a mixing device, and
(b) in a second method step (b) following the first method step (a), the plurality of objects is mixed and irradiated with laser radiation.

For this preferred and special embodiment, all features, particularities, advantages previously described in the context of the general method apply accordingly.

In the context of the present invention, a plurality means a quantity n of parts ≥10, preferably ≥100, preferably ≥500, preferably ≥1,000, more preferably ≥10,000.

An exact number of parts always depends on the possibilities and dimensions of the apparatuses used.

Furthermore, it can be provided within the scope of the present invention that the irradiation with laser radiation is continuous, or discontinuous or pulsed, preferably pulsed. In this context, continuous irradiation with laser radiation means the use of a continuous laser (cw laser, continuous wave laser). Discontinuous irradiation with laser radiation is to be understood in particular as the use of a pulsed laser which emits laser radiation or laser pulses at a high frequency (also called PRR pulses or repetition rate).

Usually, in the context of the present invention, it is envisaged that one or more lasers are used for irradiation with laser radiation. Furthermore, it is possible that each laser comprises one or more laser heads—or working heads. Within the scope of the present invention, it may therefore be envisioned that one laser or several lasers and/or one laser head or several laser heads are used for the irradiation with laser radiation. Preferably, within the scope of the present invention, several lasers or laser heads are used for processing the objects. In this way, the processing result can be improved or the efficiency or throughput can be increased.

Likewise, it can be provided that the lasers and/or laser heads are arranged in one or more in, particular parallel to each other, planes in the apparatus. Furthermore, the lasers and/or laser heads can be arranged in the individual planes parallel to each other and/or offset from each other, in particular staggered. Both continuous and discontinuous laser beam systems can be used here.

Furthermore, it is equally possible that the irradiation of the objects with laser radiation with the multiple lasers and/or multiple laser heads within the scope of the method according to the invention takes place parallel or from different angles, i.e. that the radiation from the lasers or laser heads acts on the objects parallel or from different angles.

Furthermore, lasers with different wavelengths can also be used, such as fiber lasers, Nd:YAG lasers, diode lasers, CO₂ lasers, etc. Among other things, this leads to an expansion of the application spectrum, in particular the cleaning spectrum.

Now, with regard to the wavelength range in which the laser radiation used in accordance with the invention lies, this can vary over a wide range. Usually, however, the laser radiation used according to the invention has a wavelength in the range from 100 to 15,000 nm, in particular 300 to 12,000 nm, preferably 400 to 12,000 nm. The wavelength range used in each case depends on the material to be processed.

For example, the use of fiber lasers, neodymium-YAG lasers as well as diode lasers is in particular suitable for removing inorganic contaminants, whereas CO₂ lasers can preferably be used to remove organic residues. Furthermore, by using different types of lasers, it is also possible to carry out not just a single surface treatment method, but several steps, such as cleaning and targeted adjustment of the surface roughness, etc., simultaneously or in immediate succession in one process.

However, other laser types, such as UKP lasers, or lasers with other wavelengths can also achieve very good results, depending on the material and material properties.

As previously stated, it is possible that one laser or multiple lasers and/or multiple laser heads are used in the context of the present invention. By using multiple lasers and/or multiple laser heads, it is possible to reduce the duration of the method or to perform multiple surface treatment steps in one method by using multiple lasers with different wavelengths.

In the context of the present invention, it may equally be provided that particles formed at the site of the surface treatment, in particular the laser treatment, are removed from the gas phase, in particular by suction. The removal of the particles from the gas phase can take place either directly at the site of the laser treatment or generally in the apparatus used according to the present invention.

Furthermore, it is equally possible for the method according to the invention to be carried out in a process atmosphere, in particular an inert gas atmosphere, preferably an argon or nitrogen atmosphere. Similarly, it is possible that purging is performed directly or indirectly with a process gas and/or compressed air at the location of the laser treatment.

Furthermore, it is usually provided in the context of the present invention that the method according to the invention, in particular the laser treatment, is monitored and controlled by sensors, either for example by optical systems or preferably by acoustic systems.

In accordance with a more preferred embodiment of the invention, it is provided that the method according to the invention is combined with further methods for surface treatment, in particular plasma irradiation or dry ice irradiation.

If the method according to the invention is combined with a further method for surface treatment, the method according to the invention as well as the further surface treatment method can be carried out either in parallel, i.e. simultaneously, or sequentially, i.e. one after the other. According to a preferred embodiment of the present invention, it is provided that the method according to the invention and the further surface treatment method are carried out sequentially, i.e. that first the method according to the invention is carried out, then a further surface treatment, such as a plasma treatment or dry ice irradiation, is carried out, and then the method according to the invention is carried out again. This procedure can be carried out several cycles until the desired surface properties are achieved.

In the context of the present invention, it is usually provided that the laser power is in the range of 100 to 100,000 W, in particular 100 to 10,000 W, preferably 200 to 5,000 W. It has been shown in the context of the present invention that sufficient pretreatment or cleaning of the surfaces can often be achieved with low laser energies in a short time, even if the surfaces of the small parts are not in the immediate focus of the laser radiation. However, higher laser powers can also be used to increase the throughput.

Particularly good results are obtained in the context of the present invention if the laser radiation comprises a focus range of 0.2 to 25 mm, in particular 0.5 to 20 mm, preferably 1.0 to 10 mm. Laser radiation with such a large focus can achieve very good cleaning results even when the previously mentioned low energies are applied. Lasers with even larger focal ranges of more than 25 mm or smaller focal ranges of 0.01 mm to 0.2 mm can also be used for some applications.

As previously stated, the laser radiation is preferably used in such a way that only a portion of the surfaces is irradiated at a time. Particularly good results are obtained in this context when the laser radiation is passed over the objects at a speed of 0 to 50,000 mm/s, in particular 2,000 to 10,000 mm/s, preferably 2,500 to 5,000 mm/s. Typically, the laser radiation is moved over the objects, but processing can also be performed with an expanded, non-moving beam.

Furthermore, various scanning strategies, in particular one-dimensional (1D) scanning methods, such as simply moving the laser between two points, or two-dimensional (2D) scanning methods, such as sweeping or zigzagging, can be used within the scope of the invention.

In addition, various beam delivery systems and beam deflection systems, in particular transmission and reflection optics, such as fiber or glass optics or mirror optics, can be used. The optics can influence corresponding process variables such as beam diameter, Rayleigh length, scanning speeds.

Particularly good results are obtained in the context of the present invention if the laser radiation is generated by means of a pulsed laser.

In this context, it has been well proven if the pulsed laser comprises a pulse duration in the range of 3 to 400 ns, in particular 30 to 300 ns, preferably 50 to 240 ns.

Similarly, particularly good results are obtained if the pulse laser comprises a pulse repetition rate in the range of 2 to 50,000 kHz. Much higher frequencies in the MHz range, but also continuous wave can be used.

Further subject-matter of the present invention—according to a second aspect of the present invention—is an apparatus for the collective pretreatment or cleaning of the surfaces of a plurality of objects, comprising a mixing device for receiving and mixing a plurality of objects, wherein the apparatus comprises at least one device, in particular at least one laser, for the irradiation of the plurality of objects with laser radiation.

The apparatus according to the invention can be, for example, an apparatus which corresponds in large parts to blasting or washing systems for the treatment of mass-produced bulk material, wherein, however, the apparatus parts which serve for the storage, conduction and discharge of the blasting or cleaning agent are omitted and instead a device for irradiation with laser radiation, in particular a laser, is integrated into the apparatus. In particular, the device for irradiation with laser radiation comprises means for generating and, if necessary, deflecting the laser radiation. Preferably, the device for irradiation with laser radiation is a laser. Preferably, the apparatus according to the present invention is a completely new type of apparatus with which a plurality of different laser-based surface treatments of mass-produced bulk material can be flexibly carried out.

Within the scope of the present invention, it is usually provided that the mixing device is selected from screws, in particular conveying screws, caterpillar belts, troughed belts, swiveling drums or rotating drums.

Furthermore, it may be provided in the context of the present invention that the apparatus comprises one or more devices for irradiation with laser radiation, in particular lasers. Similarly, it may be provided that individual devices for irradiation with laser radiation comprise one or more laser heads. In the context of the present invention, it may thus be provided that the apparatus comprises one or more devices for irradiation with laser radiation, in particular lasers, and/or one or more laser heads. Particularly good results are obtained in the context of the invention if the apparatus comprises several devices for irradiation with laser radiation, in particular laser, and/or or several laser heads.

Furthermore, it may be provided within the scope of the present invention that the devices for irradiation with laser radiation, in particular lasers, and/or or the plurality of laser heads are arranged in one or more, in particular parallel to each other, planes in the apparatus. In this context, it is possible that the devices for irradiation with laser radiation, in particular lasers, and/or or the plurality of laser heads are arranged in individual planes parallel to each other or offset from each other.

Furthermore, the laser devices and/or laser heads may be arranged in the apparatus such that the plurality of objects may be irradiated from parallel or different angles.

Further, within the scope of the present invention, it may be provided that the devices for irradiating with laser radiation, in particular lasers, and/or the plurality of laser heads emit different wavelengths.

Furthermore, it may be provided in the context of the present invention that the apparatus comprises at least one device for removing gases and/or particles from the gas phase. In particular, the apparatus preferably comprises a suction unit.

Similarly, it may be provided that the apparatus comprises at least one device for generating a special process atmosphere, in particular an inert gas atmosphere, for example an argon and/or nitrogen atmosphere, and/or that the apparatus comprises at least one device for purging the gas space, in particular the site of the laser treatment, with a process gas and/or compressed air.

Generally, it is provided in the context of the present invention that the device comprises sensors and a control unit for monitoring and controlling the processes to be performed. In particular, both optical and acoustic sensors may be used.

Furthermore, it may be provided that within the scope of the present invention the apparatus comprises devices for carrying out further surface treatment processes. In particular, the devices for carrying out the further surface treatment processes may be devices for irradiation with plasma and/or for irradiation with dry ice. Preferably, the apparatus can be controlled in such a way that the method according to the invention and the further surface treatment method can be carried out in parallel or sequentially, in particular alternately.

Particularly good results are obtained in the context of the present invention if the laser device is a pulse laser.

Within the scope of the present invention, it may be provided that the apparatus is configured for continuous or discontinuous surface treatment or pretreatment or cleaning of the plurality of metallic or metal-containing or generally objects.

In this regard, continuous pretreatment or cleaning may be accomplished in particular by the use of screw conveyors and caterpillar belts, whereas in discontinuous pretreatments such cleaning is typically accomplished in batch mode, for example, by the use of troughed belts, rotary drums and swiveling drums.

For further details on this aspect of the present invention, reference can be made to the above explanations on the method according to the invention, which apply accordingly with respect to the inventive apparatus.

Again, further subject-matter of the present invention—according to a third aspect of the present invention—is a method for coating a plurality of objects, wherein first the surfaces of the plurality of objects are collectively cleaned, as previously described or in the previously described apparatus, and subsequently the plurality of objects is coated.

In accordance with this aspect of the present invention, the surface treatment method is carried out as a cleaning method.

In accordance with the present invention, it may further be envisioned that the objects are coated with a decorative and/or functional coating.

In accordance with this aspect of the invention, it is more preferably the case that the objects are metallic or metal-containing objects.

Particularly good results are obtained if the coating to be applied is a functional coating in the form of an anti-corrosion coating. Preferably, zinc-containing anti-corrosion coatings are applied in the context of the present invention. In this context, it has been well proven if zinc-containing corrosion protection coatings comprise zinc or zinc alloys, in particular selected from zinc-magnesium alloys, zinc-aluminum alloys, zinc-magnesium-aluminum alloys or zinc-nickel alloys.

Preferably, the zinc-containing corrosion protection coating is a zinc flake coating or an electroplated zinc coating.

For further details on this aspect of the invention, reference may be made to the above explanations on the further aspects of the invention, which apply analogously with respect to the method according to the invention.

The subject-matter of the present invention is explained below in a non-limiting manner with reference to the figure representations and the working examples:

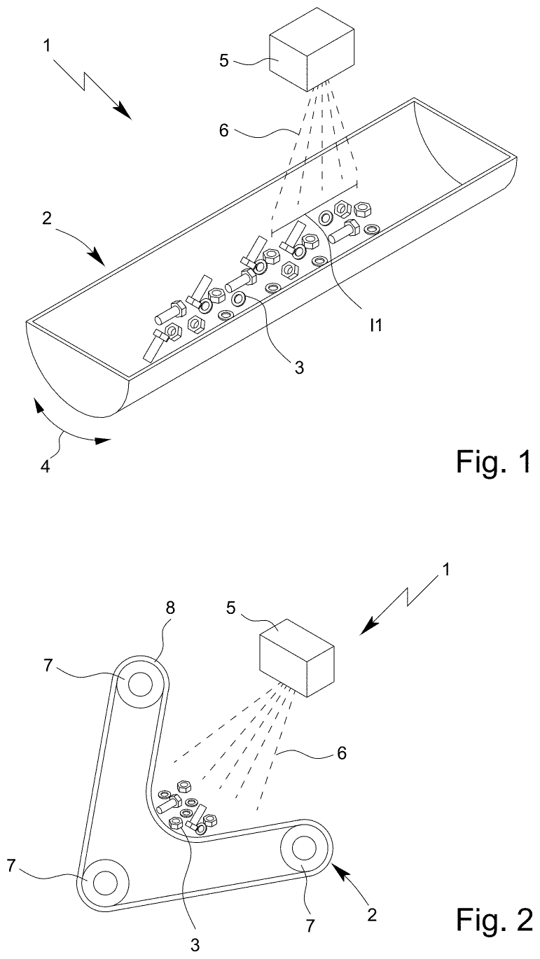

FIG. 1 shows an apparatus 1 according to the invention for carrying out the method according to the invention by way of example in the form of a cleaning process. The apparatus 1 comprises a mixing device 2, which is designed as a swivel drum as shown in the figure. The embodiment of the apparatus according to the invention shown in FIG. 1 is thus suitable for carrying out the method according to the invention in batch mode.

For carrying out the method, the mixing device 2 is filled with a plurality of metallic objects 3, in particular small parts, wherein the objects 3 are preferably arranged in loose bulk in the mixing device 2, more preferably in several layers. A representation of a larger number of objects 3 has been omitted for reasons of clarity.

In order to achieve thorough mixing of the objects 3 during the pretreatment or cleaning process, the mixing device 2 in the form of the swivel drum is swiveled about a swivel axis in directions of movement 4. This achieves constant mixing of the objects 3. For the pretreatment or cleaning of the metallic objects 3, laser radiation 6 is generated by means of a device for irradiation with laser radiation 5, which is guided over the bulk of the objects 3 at least in certain areas, in particular over a length L1. By mixing the objects 3, in particular by swiveling the mixing device 2, it is achieved that all surfaces of the objects 3 can be reached by the laser radiation 6. Surprisingly, it has been found that not all objects 3 always have to be located exactly in the focus of the laser radiation 3; rather, adjacent areas are also cleaned.

The apparatus 1 can optionally comprise several lasers 5, so that larger areas of the mixing device 2 can be simultaneously covered by the laser radiation 6. The device for irradiating with laser radiation 5 is preferably a pulsed laser with a power in the range of 600 to 5,000 W. The focus of the laser radiation can be varied. The pulse repetition duration is, for example, 5 to 50 KHz.

The apparatus according to the invention may further comprise other devices, such as transport devices for feeding the objects 3 into the apparatus 1 and for further transporting them in the apparatus. Preferably, the apparatus 1 according to the invention is a device which is used for blast cleaning of mass-produced bulk material, wherein only devices which relate to the transport as well as the distribution of blasting medium in the mixing device 2 are replaced by the laser device 5.

FIG. 2 shows a further embodiment of the apparatus according to the invention for carrying out the method according to the invention discontinuously, in particular for carrying out the method according to the invention in batch mode. The mixing device 2 is designed in the form of a troughed belt, in which a belt 8 is guided over various rollers 7 and is driven by them. The belt comprises a trough at one point in which the plurality of metallic objects 3 are located. As already described in the context of FIG. 1, the apparatus 1 further comprises a laser device 5 which irradiates the surface of the metallic parts 3 with laser radiation 6.

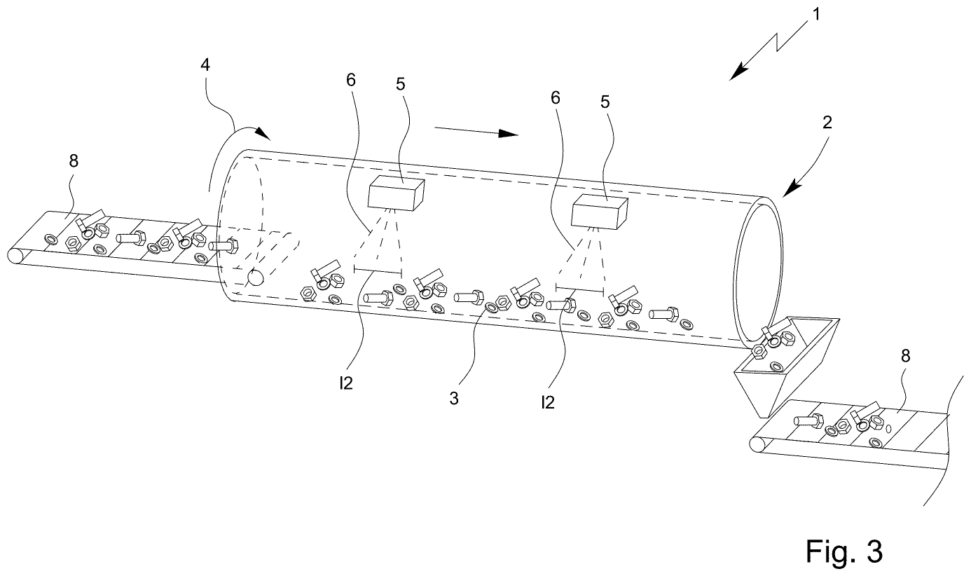

FIG. 3 shows an apparatus 1 according to the invention for carrying out the method according to the invention. The apparatus 1 comprises a mixing device 2, shown here in the form of a rotary drum, which is rotatable in a direction 4. In order to carry out the method according to the invention, metallic objects 3 are fed in loose bulk via belts 8 into the mixing device 2, which rotates in direction 4, and are further transported by the latter. While the metallic objects 3 are guided through the mixing device 2, the parts are irradiated with laser radiation 6 from several devices for irradiation with laser radiation 5, in particular lasers, wherein each laser device 5 irradiates only a certain length L2 within the mixing device 2. The method according to the invention can be carried out on devices 1 which are used for the pretreatment or cleaning of mass-produced bulk material by means of blasting media, wherein only devices which serve for the supply of blasting media, the treatment of the bulk material with the blasting medium and the discharge of spent blasting medium are to be replaced by one or more devices for irradiation with laser radiation 5 in the apparatus 1.

### EXAMPLES

To demonstrate the method according to the invention, an apparatus which can convey and circulate bulk material and comprises a rotating drum is equipped with a pulsed fiber laser. The pulsed fiber laser with an average power of 750 W is placed in the drum at a distance of about 10 cm. The laser is adjusted so that an area approximately 20 cm long can be cleaned while scanning. The laser spot can be varied. The pulse duration is 150 ns. The drum is filled with 20 kg of screws and set in rotation to allow movement and thus uniform cleaning. In parallel, the laser is operated with the aforementioned parameters. Very good pretreatment or cleaning results can be achieved by running the method for 15 minutes. The cleaned surfaces are analyzed using EDX.

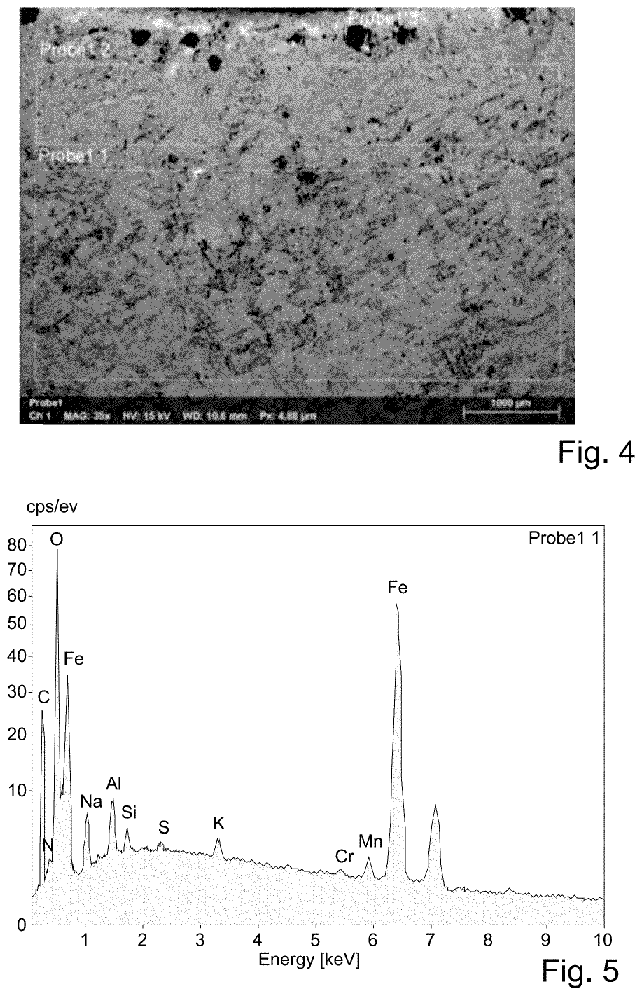

FIGS. 4 and 5 show an EDX analysis of a screw head in scaled and oiled condition.

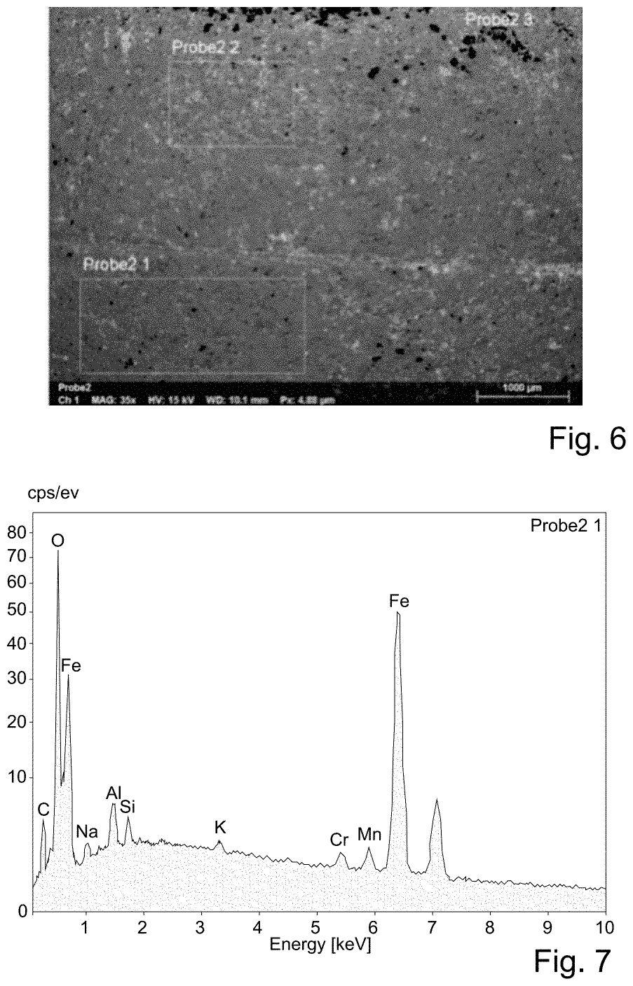

FIGS. 6 and 7 show an EDX analysis of a screw head after conventional treatment, i.e. hot alkaline degreasing and blasting. It can be seen that compared to the oiled and scaled screw, the amount of alkali metals, sulfur and carbon on the surface has been significantly reduced. Also, the microscopic image of the surface shows a much more compact image without adhesion.

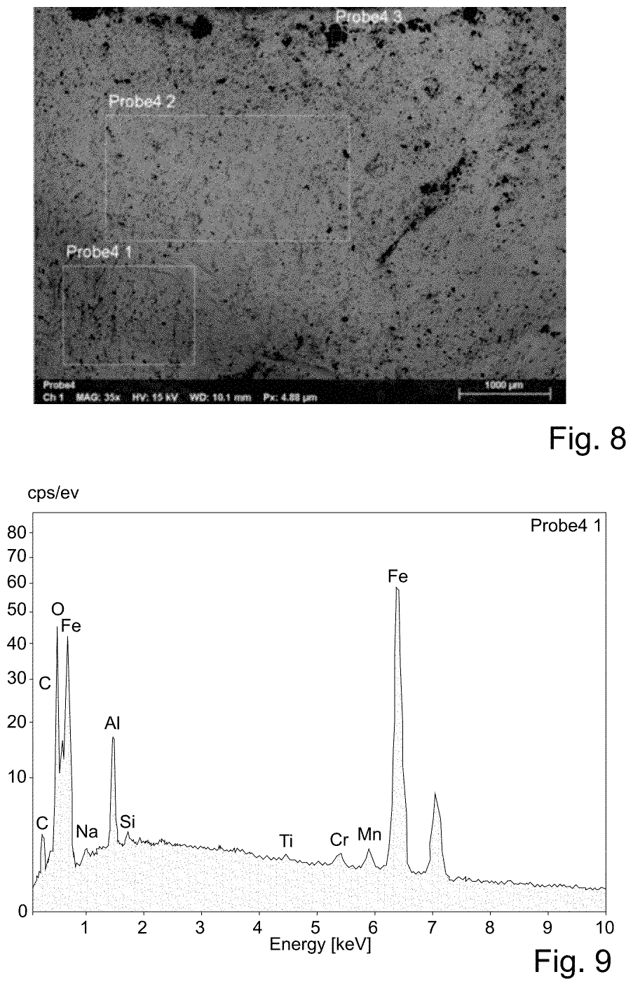

FIGS. 8 and 9 show how an EDX analysis of a screw head after pretreatment or cleaning according to the invention. Here, too, it can be seen that, compared with the untreated screw, the adhesion of alkali metals and carbon has been significantly reduced. Similarly, the adhesion of oxygen-containing compounds on the surface is also significantly reduced.

It can thus be seen that a similar surface profile is created in the course of the pretreatment for cleaning according to the invention as in the course of hot degreasing and blasting.

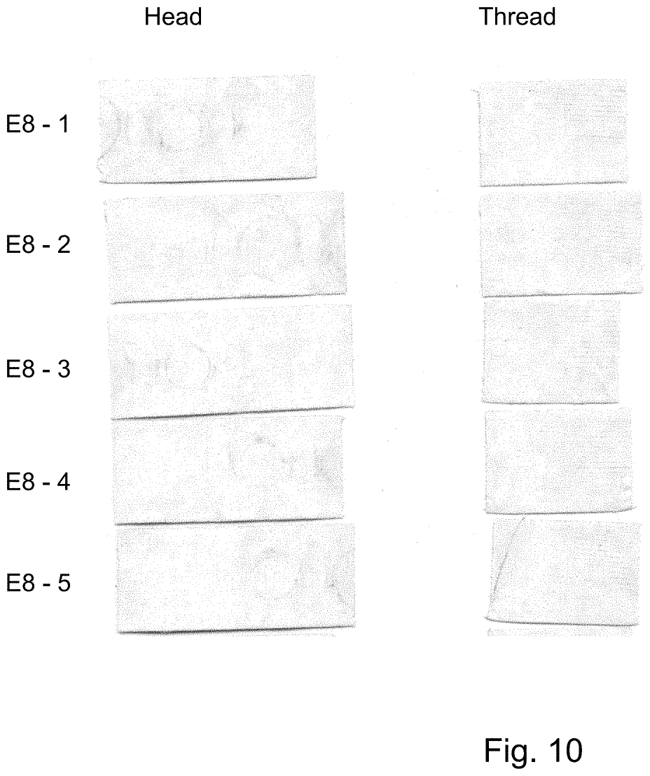

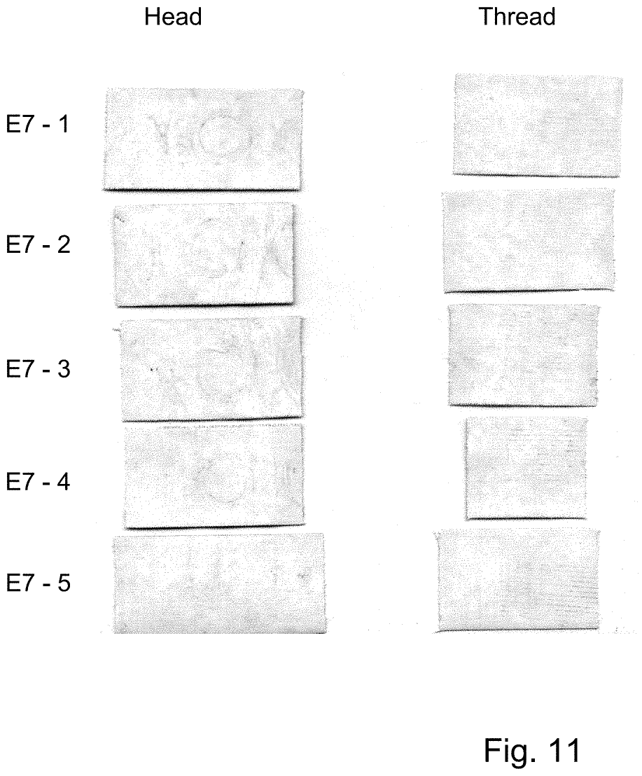

A paint adhesion test is carried out in accordance with DIN EN ISO 10683. For this purpose, the cleaned screws are coated with a zinc flake coating and then the adhesion test is carried out in accordance with DIN EN ISO 10683 using adhesive tapes. FIGS. 10 and 11 show the respective results against each other. FIG. 10 shows the adhesion test on a screw which was first degreased with hot alkali and then irradiated. FIG. 11 shows the corresponding tape breaks after preceding laser cleaning.

It can be seen that in both cases the tear-off of the coatings is comparable, i.e. that comparable adhesion is achieved on the screws.

This is also shown in the supplementary salt spray test, which also shows that the screws cleaned by the methods according to the invention achieve good corrosion protection values of more than 1,000 hours in the salt spray test according to DIN EN ISO 9227. The method according to the invention thus provides a significantly simplified, more economical and more sustainable way of pretreating or cleaning mass-produced bulk material than the usual methods in the prior art. In particular, a two-stage process consisting of degreasing and subsequent irradiation can be dispensed with.

Reference signs

| | | | |
|---|---|---|---|
| 1 | Apparatus | 5 | Device for irradiation with |
| 2 | Mixing device | | laser radiation |
| 3 | Metallic or metal-containing | 6 | Laser radiation |
| | objects | 7 | Roller |
| 4 | Direction of rotation | 8 | Belt |

What is claimed is:

1. A method of cleaning surfaces of a plurality of objects, comprising: irradiating the surfaces with laser radiation.

2. The method of claim 1, wherein the objects are present in bulk or in the form of a multilayer bulk.

3. The method of claim 1, wherein the objects are present in the form of bulk material or mass-produced bulk material.

4. The method of claim 1, wherein the objects are made of a material selected from wood, plastic, ceramic, metal and mixtures thereof.

5. The method of claim 1, wherein the objects are selected from screws, nuts, bolts, rivets, stamped parts, stamped-bent parts, cast parts, pressed parts and combinations thereof.

6. The method of claim 1, wherein:
the position of the individual objects relative to one another is changed during cleaning; and/or
the objects are mixed during cleaning.

7. The method of claim 6, wherein:
the position of the individual objects relative to one another is continuously changed during cleaning; and/or
the objects are continuously mixed during cleaning.

8. The method of claim 1, wherein the cleaning is carried out continuously or discontinuously.

9. The method of claim 1, wherein the irradiating is carried out area-wise.

10. The method of claim 1, wherein the irradiating is carried out continuously or discontinuously.

11. The method of claim 1, wherein one laser or several lasers and/or one laser head or several laser heads are used for the irradiating.

12. The method of claim 11, wherein:
the several lasers and/or the several laser heads are arranged in one or more parallel planes in an apparatus, wherein within each individual plane, the several lasers and/or several laser heads are arranged in parallel with each other, offset to each other and/or staggered; or
the irradiating is carried out with the several lasers and/or the several laser heads arranged in parallel or from different angles.

13. The method of claim 1, wherein:
the plurality of objects is first introduced into a mixing device, and
thereafter the plurality of objects is mixed and irradiated with the laser radiation.

14. The method of claim 1, wherein:
the method is carried out in a process atmosphere;
the irradiation is monitored and controlled by sensors; and/or
the method further comprises treating the surfaces by plasma irradiation or dry ice irradiation.

15. An apparatus for the collective cleaning of the surfaces of a plurality of objects, comprising a mixing device for receiving and mixing a plurality of objects, wherein
the apparatus comprises at least one laser device for irradiation of the plurality of objects with laser radiation.

16. The apparatus of claim 15, wherein the mixing device is selected from screws, conveyor screws, caterpillar belts, troughed belts, swivel drums and rotary drums.

17. The apparatus of claim 15, wherein the apparatus comprises more than one laser device, wherein each individual laser device comprises one or more laser heads.

18. The apparatus of claim 17, wherein the laser devices are arranged in one or more parallel planes in the apparatus, wherein within each individual plane, the laser devices are arranged in parallel or offset to each other.

19. A method for coating a plurality of objects, comprising:
cleaning a plurality of surfaces of the plurality of objects are collectively cleaned by irradiating the surfaces with laser radiation, and subsequently coating the plurality of cleaned objects.

20. The method of claim 19, wherein the objects are coated with a decorative coating, a functional coating, or both.
